(19) United States
(12) Patent Application Publication
(10) Pub. No.: US 2026/0318771 A1
(43) Pub. Date: Oct. 15, 2026

(54) MULTIFUNCTIONAL TESTING EQUIPMENT

(71) Applicant: Foxconn Internet Advanced Technology (Shaoxing) Co., Ltd, Shaoxing (CN)

(72) Inventors: Ming-Yuan Wu, Shaoxing (CN); Chun-Yu Shih, New Taipei (TW); Zhi-Kun Deng, Shaoxing (CN)

(21) Appl. No.: 19/369,106

(22) Filed: Oct. 24, 2025

(30) Foreign Application Priority Data
Apr. 9, 2025 (CN) 202520663191.3

(51) Int. Cl. G01M 3/28; B08B 9/032; G01D 21/02

(52) U.S. Cl. CPC G01M 3/2815; B08B 9/032; G01D 21/02

(57) ABSTRACT

The present application pertains to the field of liquid cooling detection equipment and relates to a multifunctional testing equipment. The multifunctional testing equipment comprises a testing component, a gas pipeline, a first liquid pipeline, a second liquid pipeline, and a control component. By selectively controlling one of the gas pipeline, the first liquid pipeline, and the second liquid pipeline to communicate with the liquid cooling pipeline of the test object via the control component, functions such as leakage detection, liquid filling, liquid draining, and cleaning of the liquid cooling pipeline in the test object can be achieved.

This application claims the patent priority of C.N. patent applications of application number 202520663191.3, and invented by MING-YUAN WU et al. The application has the same assignee as the present application. The above-identified application is incorporated herein by reference.

### FIELD

The subject matter relates to liquid-cooled testing equipment, and more particularly, to a multifunctional testing equipment.

### BACKGROUND

With the rapid advancement of computer technology, heat generation of servers and data centers has increased dramatically, and a traditional air cooling system is unable to meet the demand. Liquid cooling systems significantly improve heat absorption and dissipation efficiency by introducing coolant directly into the server, ensuring the stable operation of the equipment, and the market demand for the liquid cooling system is increasing.

In the production and manufacturing process of liquid cooling systems, leak testing for both gas and liquid is often required for the liquid cooling pipelines. Additionally, after the leak testing is completed, further steps such as cleaning, sterilization, drying, and liquid injection are performed based on different customer requirements.

However, during the aforementioned production processes, each procedure requires the use of specialized testing equipment, for example, employing a leak detector for leak testing or a pipeline cleaning machine for cleaning. Moreover, when transitioning between different process steps, manual handling is required to transport the test products between multiple testing devices. This results in high labor intensity, low testing efficiency, and an inability to meet the demands of high-efficiency production.

Therefore, there is room for improvement in the art.

### BRIEF DESCRIPTION OF THE DRAWINGS

FIG. 1 is a diagrammatic view of a structural composition of a multifunctional testing equipment according to an embodiment of the present application.

FIG. 2 is a diagrammatic view of a coolant flow direction in the multifunctional testing equipment during a liquid-filling process to an embodiment of the present application.

FIG. 3 is a diagrammatic view of the cleaning liquid flow direction in the multifunctional testing equipment during a cleaning process to an embodiment of the present application.

FIG. 4 is a diagrammatic view of a gas flow direction in the multifunctional testing equipment during a leak detection process to an embodiment of the present application.

FIG. 5 is a diagrammatic view of the airflow direction in the multifunctional testing equipment during a liquid-discharge process, wherein a gas heating component is in an off state, according to an embodiment of the present application.

FIG. 6 is a diagrammatic view of the airflow direction in the multifunctional testing equipment during a drying process, wherein the gas heating component is in an on state, according to an embodiment of the present application.

### DETAILED DESCRIPTION

Implementations of the present technology will now be described, by way of example only, with reference to the attached figures.

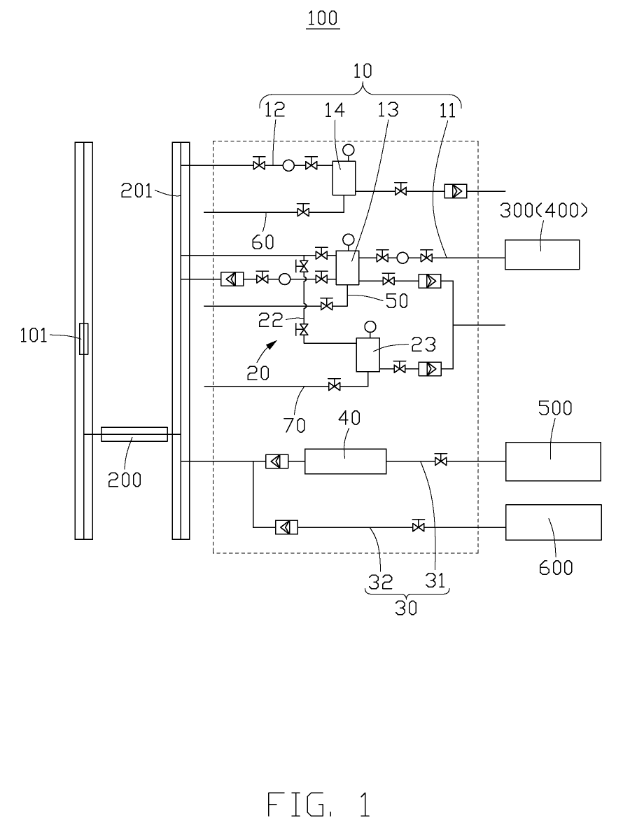

Referring to FIG. 1, an exemplary embodiment of the present application provides a multifunctional testing equipment 100. The multifunctional testing equipment 100 is configured to detect a test object 200. For example, the test Object 200 could be a sensor box, etc. The test object 200 is provided with a liquid cooling pipeline 201, which is configured to be filled with coolant. The coolant absorbs heat from the test object 200 to cool the test object 200.

In the exemplary embodiment, the multifunctional testing equipment 100 comprises a testing component 101, a first liquid pipeline 10, a second liquid pipeline 20, a gas pipeline 30, and a control component 102. The testing component 101 is configured to be installed in the test object 200 to monitor various parameters within the liquid cooling pipeline 201, such as pressure, flow rate, or temperature.

In an embodiment, the testing component 101 comprises a single sensor. The single sensor can detect multiple parameters, such as pressure, flow rate, or temperature.

In another embodiment, the testing component 101 comprises multiple sensors, with each sensor detecting a corresponding parameter, such as pressure, flow rate, or temperature, which can be selected based on actual conditions.

In the exemplary embodiment, the control component 102 is configured to connect the first liquid pipeline 10, the second liquid pipeline 20, and the gas pipeline 30, respectively. The control component 102 is configured to selectively control at least one of the first liquid pipeline 10, the second liquid pipeline 20, and the gas pipeline 30 to be in fluid communication with the liquid cooling pipeline 201 of the test object 200.

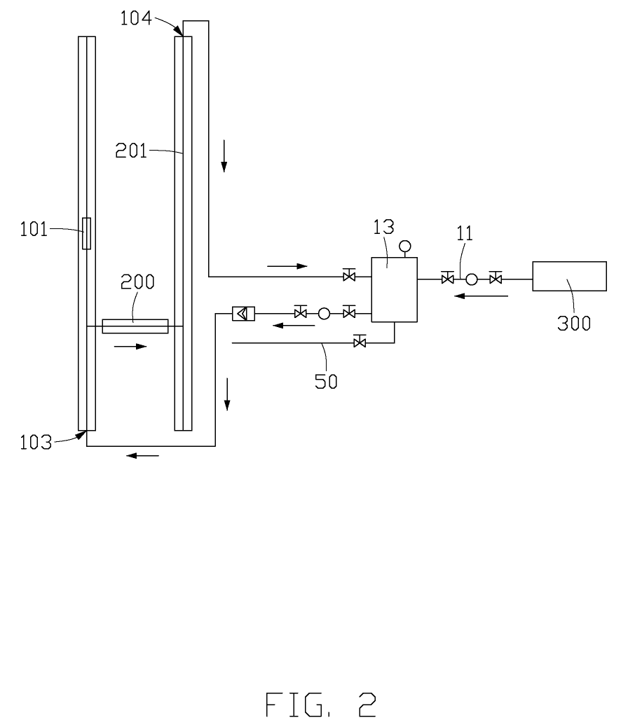

Referring to FIGS. 1 and 2, in the exemplary embodiment, the first liquid pipeline 10 is configured to be in fluid communication with the liquid cooling pipeline 201 and the coolant storage device 300, allowing the coolant in the coolant storage device 300 to be injected into the liquid cooling pipeline 201 via the first liquid pipeline 10. The testing component 101 is configured to monitor the flow rate of the coolant in the liquid cooling pipeline 201.

During the liquid-filling process of the test object 200, the control component 102 adjusts the first liquid pipeline 10 to be in fluid communication with the liquid cooling pipeline 201. The coolant storage device 300 injects the coolant into the liquid cooling pipeline 201 through the first liquid pipeline 10, and the testing component 101 monitors the flow rate of the coolant in the liquid cooling pipeline 201 to determine whether the liquid cooling pipeline 201 is fully filled.

In the exemplary embodiment, the testing component 101 monitors the pressure changes within the liquid cooling pipeline 201 and the flow rate of the coolant to determine whether the liquid cooling pipeline 201 is fully filled, which enhances the accuracy of the multifunctional testing equipment 100 in assessing the filling status of the liquid cooling pipeline 201.

For example, the testing component 101 monitors the total volume of coolant injected into the liquid cooling pipeline 201 while also monitoring the pressure changes within the liquid cooling pipeline 201. When the pressure value in the liquid cooling pipeline 201 reaches its maximum set value and the measured total liquid volume matches the capacity of the liquid cooling pipeline 201, it indicates that the liquid cooling pipeline 201 is fully filled with coolant; otherwise, it indicates that the liquid cooling pipeline 201 is not fully filled.

In another embodiment, the determination of whether the liquid cooling pipeline 201 is fully filled could be made based on one of the flow monitoring results or pressure monitoring results, or by other means, which could be selected according to the actual situation.

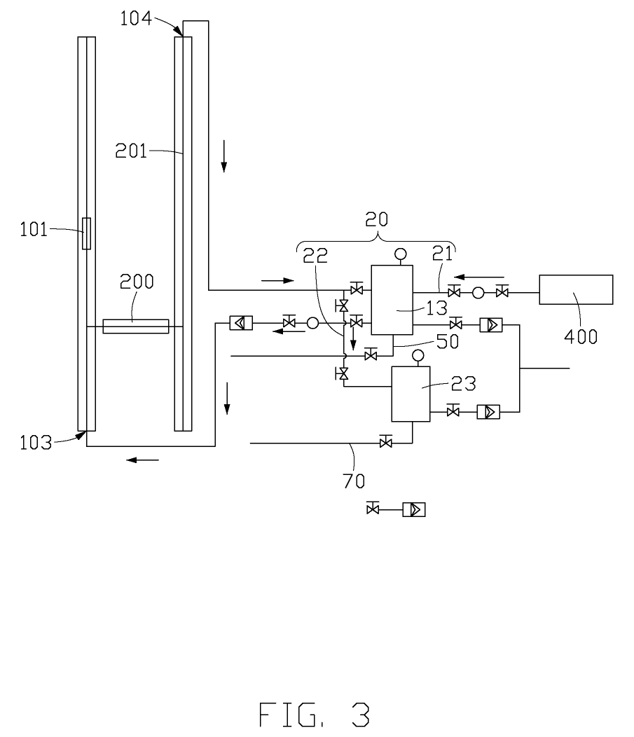

Referring to FIGS. 1 and 3, in the exemplary embodiments, the second liquid pipeline 20 is configured to be in fluid communication with the liquid cooling pipeline 201 and the cleaning liquid storage device 400, allowing the cleaning liquid in the cleaning liquid storage device 400 to flow into the liquid cooling pipeline 201 via the second liquid pipeline 20, thereby cleaning the liquid cooling pipeline 201.

When cleaning the test object 200, the control component 102 adjusts the second liquid pipeline 20 to be in fluid communication with the liquid cooling pipeline 201, enabling the cleaning liquid from the cleaning liquid storage device 400 to flow into the liquid cooling pipeline 201, thereby cleaning the liquid cooling pipeline 201.

The multifunctional testing equipment 100 cleans the liquid cooling pipeline 201 based on predetermined time and flow rate settings, such as performing circulating cleaning or flow-through cleaning.

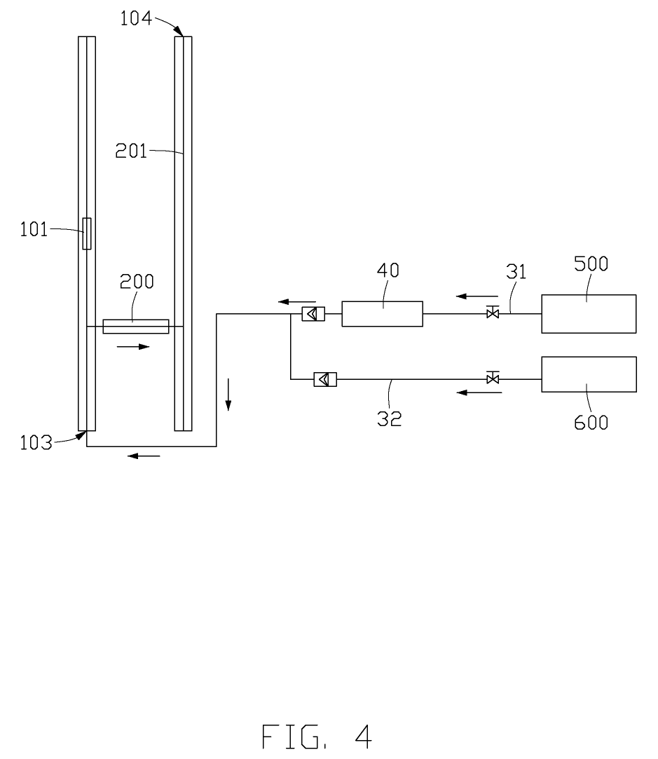

Referring to FIGS. 1 and 4, in the exemplary embodiment, the gas pipeline 30 is configured to be in fluid communication with the liquid cooling pipeline 201 and an external gas source, such as air compressor 500 or an inert gas storage device 600, allowing gas to flow into the liquid cooling pipeline 201 via the gas pipeline 30. The testing component 101 is configured to monitor pressure changes in the liquid cooling pipeline 201.

During leak testing of the test object 200, the control component 102 adjusts the gas pipeline 30 to be in fluid communication with the liquid cooling pipeline 201. The external gas source delivers gas through the gas pipeline 30 into the liquid cooling pipeline 201, forming a sealed test loop, where the gas is air or an inert gas, such as N₂ [nitrogen].

The testing component 101 monitors the pressure changes within the liquid cooling pipeline 201. If the pressure curve remains nearly horizontal, the liquid cooling pipeline 201 is leak-free and meets requirements. If the pressure curve shows a declining trend, the liquid cooling pipeline 201 has a leak and does not meet requirements.

For example, the external gas source delivers compressed air through the gas pipeline 30 into the liquid cooling pipeline 201. When the internal pressure in the liquid cooling pipeline 201 reaches 1.5 kPa, the external gas source stops supplying compressed air. The testing component 101 then records pressure changes in real time. If the pressure curve remains nearly horizontal (e.g., fluctuations < 0.5 kPa/min), it is determined that the liquid cooling pipeline 201 has no leakage and meets requirements. If the pressure curve declines (e.g., by 1 kPa per minute), it is determined that the liquid cooling pipeline 201 has leakage and does not meet requirements.

In another embodiment, the liquid cooling pipeline 201 could employ alternative leak detection methods, such as using mass spectrometry with tracer gases (e.g., helium), and the appropriate method can be selected based on actual conditions.

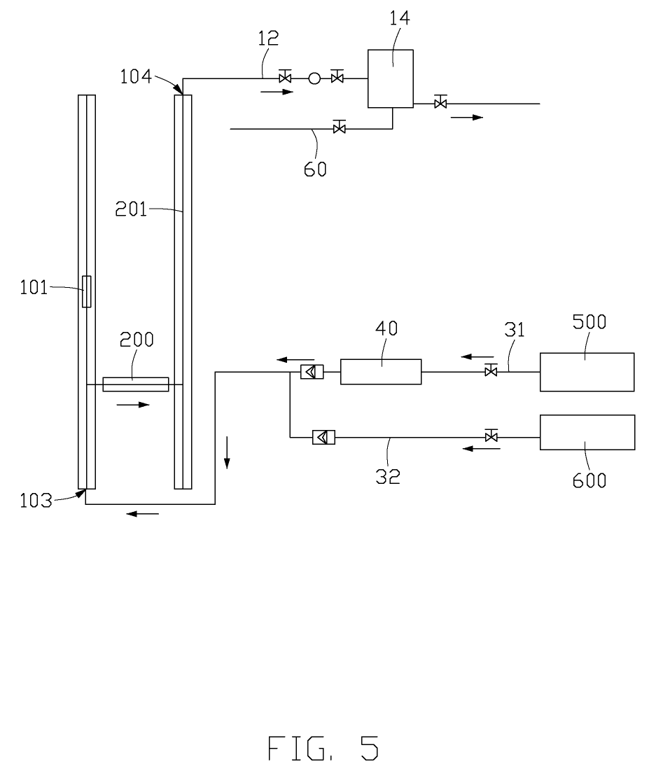

Referring to FIGS. 1 and 5, in the exemplary embodiment, during the drainage of the test object 200, the control component 102 adjusts the fluid communication between the gas pipeline 30 and the liquid cooling pipeline 201 of the test object 200. The external gas source delivers gas into the liquid cooling pipeline 201 via the gas pipeline 30. The liquid cooling pipeline 201 does not form a closed loop, allowing the coolant inside the liquid cooling pipeline 201 to be expelled under the action of the gas.

The multifunctional testing equipment 100 provided in the present application selectively controls one or more of the first liquid pipeline 10, the second liquid pipeline 20, and the gas pipeline 30 to be in fluid communication with the liquid cooling pipeline 201 via the control component 102, enabling the test object 200 to undergo multiple processes, including leak detection, filling, drainage, and cleaning for liquid cooling pipeline 201.

Compared to traditional setups where multiple pieces of equipment perform multiple processes on the liquid cooling pipeline 201, the multifunctional testing equipment 100 provided in the present application integrates leak detection, filling, drainage, and cleaning processes into a single unit. Technicians no longer need to transfer the test object 200 between different devices, which helps reduce the number of equipment required, lowers technicians' workload intensity, and improves production efficiency.

Additionally, using the multifunctional testing equipment 100 eliminates the need for frequent plugging and unplugging of connections, thereby minimizing the leakage of gases and liquids during interface operations and reducing energy consumption and environmental hazards.

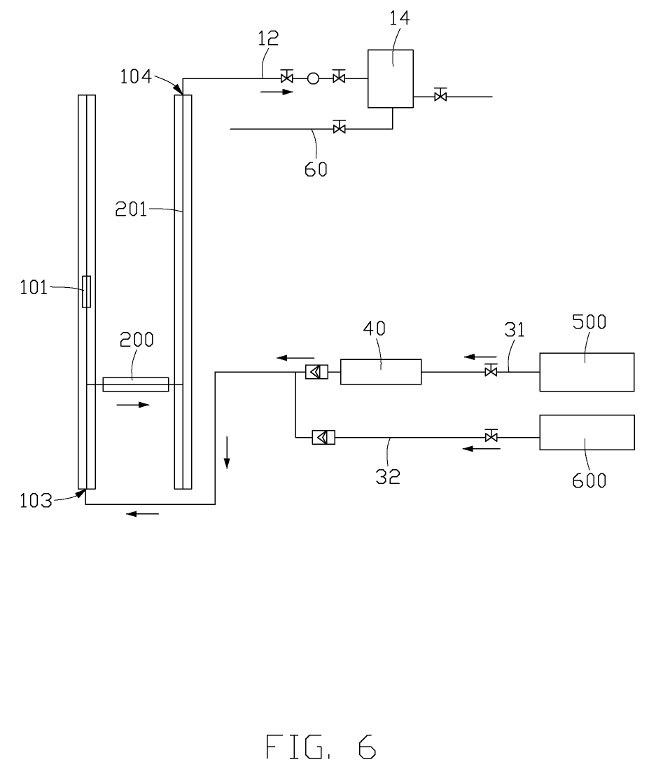

Referring to FIGS. 1 and 6, in the exemplary embodiment, the multifunctional testing equipment 100 further comprises a gas heating component 40, which is installed on the gas pipeline 30 and connected to the control component 102. The gas heating component 40 is configured to heat the gas flowing through the gas pipeline 30 so that the heated gas can dry the liquid cooling pipeline 201.

When drying the liquid cooling pipeline 201, the control component 102 adjusts the fluid communication between the gas pipeline 30 and the liquid cooling pipeline 201 of the test object 200. The external gas source delivers gas into the liquid cooling pipeline 201 via the gas pipeline 30. The gas heating component 40 operates to heat the gas flowing through the gas pipeline 30, and the heated gas then dries the liquid cooling pipeline 201.

By incorporating the gas heating component 40, the multifunctional testing equipment 100 achieves a drying process for the test object 200, further enhancing its multifunctionality and, consequently, improving production efficiency. Additionally, the gas heating component 40 helps mitigate the risk of damage to the test object 200 caused by prolonged moisture retention in the liquid cooling pipeline 201.

In the exemplary embodiment, the gas heating component 40 is configured to be an electric heating wire or heating tube, converting electrical energy into thermal energy to heat the flowing gas. In another embodiment, the gas heating component 40 may be selected based on actual requirements.

In the exemplary embodiment, the multifunctional testing equipment 100 further comprises a first humidity detection component 103 and a second humidity detection component 104. The first humidity detection component 103 is configured to be arranged at the inlet of the liquid cooling pipeline 201 to monitor the humidity value at the inlet. The second humidity detection component 104 is configured to be arranged at the outlet of the liquid cooling pipeline 201 to monitor the humidity value at the outlet.

By incorporating the first humidity detection component 103 and the second humidity detection component 104, the multifunctional testing equipment 100 is conductive to confirming the degree of the dryness of the liquid cooling pipeline 201.

For example, during the drying operation of the liquid cooling pipeline 201, the first humidity detection component 103 measures the humidity value at the inlet of the liquid cooling pipeline 201 to generate a first humidity value. The second humidity detection component 104 measures the humidity value at the outlet of the liquid cooling pipeline 201 to generate a second humidity value. If the first humidity value and the second humidity value are equal, the liquid cooling pipeline 201 is fully dried. If the first humidity value and the second humidity value are not equal, the liquid cooling pipeline 201 is not yet fully dried, and the drying process needs to be continued.

In the exemplary embodiment, the first humidity detection component 103 and the second humidity detection component 104 are dew point sensors, in alternative embodiments, the humidity detection components (103, 104) may comprise other structural arrangements, and the multifunctional testing equipment 100 may employ other methods to determine the drying status of the liquid cooling pipeline 201.

Please refer to FIGS. 1, 2 and 5, in the exemplary embodiment, the first liquid pipeline 10 comprises a first liquid inlet branch 11 and a first liquid outlet branch 12. The first liquid inlet branch 11 is configured to be in fluid communication with the inlet of the liquid cooling pipeline 201 and the coolant storage device 300, enabling coolant from the coolant storage device 300 to be injected into the liquid cooling pipeline 201 through the first liquid inlet branch 11.

The first liquid outlet branch 12 is configured to be in fluid communication with the outlet of the liquid cooling pipeline 201, and the inlet of the liquid cooling pipeline 201 is in fluid communication with the gas pipeline 30. When gas from the gas pipeline 30 flows into the liquid cooling pipeline 201, the coolant inside the liquid cooling pipeline 201 is expelled through the first liquid outlet branch 12.

When filling test object 200, the control component 102 activates the fluid communication between first liquid inlet branch 11 and liquid cooling pipeline 201. The coolant storage device 300 delivers coolant through first liquid inlet branch 11 into liquid cooling pipeline 201. During drainage of test object 200, control component 102 activates the fluid communication between the first liquid outlet branch 12 and the liquid cooling pipeline 201, and the fluid communication between the gas pipeline 30 and the liquid cooling pipeline 201. An external gas supply forces gas through gas pipeline 30 into liquid cooling pipeline 201, and the coolant in the liquid cooling pipeline 201 is discharged along the first liquid outlet branch 12 under the action of the gas.

Technicians can install the first liquid inlet branch 11 and the first liquid outlet branch 12 at the same time, which is conducive to improving the efficiency of first liquid pipeline 10 installation. When one of the first liquid inlet branch 11 or first liquid outlet branch 12 is damaged and aged, the technician needs to replace the corresponding branch, and does not need to replace the entire first liquid pipeline 10, which is conducive to reducing the maintenance cost of multifunctional testing equipment 100.

Please refer to FIGS. 1 and 3, in the exemplary embodiment, the second liquid pipeline 20 comprises a second liquid inlet branch 21 and a second liquid outlet branch 22. The second liquid

inlet branch 21 is configured to be in fluid communication with the inlet of the liquid cooling pipeline 201 and the cleaning liquid storage device 400. The second liquid outlet branch 22 is configured to be in fluid communication with the outlet of the liquid cooling pipeline 201, enabling the cleaning liquid from the cleaning liquid storage device 400 to flow into the liquid cooling pipeline 201 through the second liquid inlet branch 21 and then exit through the second liquid outlet branch 22.

When cleaning the test object 200, the control component 102 adjusts the fluid communication of the second liquid inlet branch 21 and the inlet of the liquid cooling pipeline 201, and the fluid communication of the second liquid outlet branch 22 and the outlet of the liquid cooling pipeline 201. The cleaning liquid from the cleaning liquid storage device 400 flows into the liquid cooling pipeline 201 through the second liquid inlet branch 21 and then exits through the second liquid outlet branch 22, thereby achieving the cleaning of the liquid cooling pipeline 201.

Technicians can install the second liquid inlet branch 21 and the second liquid outlet branch 22 simultaneously, thereby improving the installation efficiency of the second liquid pipeline 20. Additionally, if either the second liquid inlet branch 21 or the second liquid outlet branch 22 becomes damaged or deteriorates, only the affected branch needs to be replaced without requiring replacement of the entire second liquid pipeline 20, which further reducing the long-term maintenance costs of the multifunctional testing equipment 100.

In the exemplary embodiment, the first liquid inlet branch 11 and the second liquid inlet branch 21 are configured as the same pipeline. The coolant from the coolant storage device 300 and the cleaning liquid from the cleaning liquid storage device 400 could flow into the liquid cooling pipeline 201 through the same pipeline, which is conducive to reduce internal piping within the multifunctional testing equipment 100 and simplify internal structure of the multifunctional testing equipment 100.

Please refer to FIGS. 2, 3 and 5, in the exemplary embodiments, the first liquid pipeline 10 further includes a first liquid storage chamber 13 and a second liquid storage chamber 14. The first liquid storage chamber 13 is arranged on the first liquid inlet branch 11 and is configured to hold the coolant flows along the first liquid inlet branch 11 into the liquid cooling pipeline 201. The second liquid storage chamber 14 is arranged on the first liquid outlet branch 12 and is configured to hold the coolant discharged from the liquid cooling pipeline 201 and along the first liquid outlet branch 12.

During liquid filling of the liquid cooling pipeline 201, the coolant could accumulate in the first liquid storage chamber 13 before entering the liquid cooling pipeline 201. During drainage operation of the liquid cooling pipeline 201, the coolant could be temporarily stored in the second liquid storage chamber 14 before being discharged. The first liquid storage chamber 13 and the second liquid storage chamber 14 help maintain gas tightness of the liquid cooling pipeline 201 during filling or drainage processes, reducing the risk of external gas or contaminants, such as dust particles, entering the liquid cooling pipeline 201. The first liquid storage chamber 13 and the second liquid storage chamber 14 could also accommodate excess coolant, minimizing the risk of leakage from the liquid cooling pipeline 201 due to overfilling.

In the exemplary embodiment, the second liquid pipeline 20 further comprises a third liquid storage chamber 23. The third liquid storage chamber 23 is arranged on the second liquid outlet branch 22 and is configured to hold cleaning liquid during outflow along the second liquid outlet branch 22.

During cleaning operations of the liquid cooling pipeline 201, the cleaning liquid could accumulate in the third liquid storage chamber 23, which helps maintain pipeline gas tightness of the liquid cooling pipeline 201 during cleaning and provides storage capacity for the excess cleaning liquid.

Refer to FIG. 1, in the exemplary embodiment, the multifunctional testing equipment 100 further comprises a first liquid discharge pipeline 50, a second liquid discharge pipeline 60, and a third liquid discharge pipeline 70. The first liquid discharge pipeline 50 is in fluid communication with the first liquid storage chamber 13, the second liquid discharge pipeline 60 is in fluid communication with the second liquid storage chamber 14, and the third liquid discharge pipeline 70 is in fluid communication with the third liquid storage chamber 23.

The first liquid discharge pipeline 50 is configured to discharge the coolant from the first liquid storage chamber 13 to the external environment. The second liquid discharge pipeline 60 is configured to discharge the coolant from the second liquid storage chamber 14 to the external environment. The third liquid discharge pipeline 70 is configured to discharge the cleaning liquid from the third liquid storage chamber 23 to the external environment.

The first liquid discharge pipeline 50, the second liquid discharge pipeline 60, and the third liquid discharge pipeline 70 allow the discharge of residual liquid from the first liquid storage chamber 13, the second liquid storage chamber 14, and the third liquid storage chamber 23, which facilitates maintenance and inspection of the multifunctional testing equipment 100.

In the exemplary embodiment, the first liquid discharge pipeline 50, the second liquid discharge pipeline 60, and the third liquid discharge pipeline 70 are configured to be manually opened or closed by users.

In another embodiment, the first liquid discharge pipeline 50, the second liquid discharge pipeline 60, and the third liquid discharge pipeline 70 could also be automatically opened or closed by the control component 102, which helps improve the intelligence level of the multifunctional testing equipment 100.

In another embodiment, the control component 102 may be omitted, allowing manual control of the fluid communication between the first liquid pipeline 10, the second liquid pipeline 20, the gas pipeline 30, and the liquid cooling pipeline 201.

Refer to FIGS. 1, 4 to 6, in the exemplary embodiment, the gas pipeline 30 comprises a first gas branch 31 and a second gas branch 32. The first gas branch 31 and the second gas branch 32 are connected to the control component 102. The gas heating component 40 is arranged on the first gas branch 31. The first gas branch 31 is configured to be in fluid communication with the external air compressor 500, while the second gas branch 32 is configured to be in fluid communication with the gas storage device 600. The control component 102 is configured to selectively control either the first gas branch 31 or the second gas branch 32 to be in fluid communication with the liquid cooling pipeline 201.

The gas storage device 600 could store inert gases such as nitrogen, but it may also hold other suitable gases.

By utilizing the first gas branch 31 and the second gas branch 32, technicians could choose to introduce either compressed air or inert gas according to customer needs. For example, if the compressed air may react chemically with the liquid in the liquid cooling pipeline 201, the inert gas could be instead.

Furthermore, if either the first gas branch 31 or the second gas branch 32 fails, the other can still function normally. The multifunctional testing equipment 100 does not require shutdown for repairs, thereby further enhancing production efficiency.

For example, the working process of the multifunctional testing equipment 100 provided in the present application is as follows:

The multifunctional testing equipment 100 performs a leak test on the test object 200. The control component 102 adjusts the gas pipeline 30 to be in fluid communication with the liquid cooling pipeline 201. The external gas source delivers gas into the liquid cooling pipeline 201 through the gas pipeline 30, forming a closed test loop. The testing component 101 monitors the pressure change within the liquid cooling pipeline 201. If the pressure curve remains nearly horizontal, the liquid cooling pipeline 201 has no leaks and meets the requirement. If the pressure curve shows a declining trend, the liquid cooling pipeline 201 has leak and does not meet the requirement.

After the leak test is completed, the multifunctional testing equipment 100 fills the test object 200 with the coolant. The control component 102 adjusts the first liquid pipeline 10 to be in fluid communication with the liquid cooling pipeline 201. The coolant storage device 300 injects coolant into the liquid cooling pipeline 201 through the first liquid pipeline 10. The testing component 101 monitors the coolant flow rate within the liquid cooling pipeline 201 to determine whether it is fully filled.

After the liquid cooling pipeline 201 is fully filled with coolant, the multifunctional testing equipment 100 drains the test object 200. The control component 102 adjusts the gas pipeline 30 to be in fluid communication with the liquid cooling pipeline 201. The external gas source delivers gas into the liquid cooling pipeline 201. The liquid cooling pipeline 201 does not form a closed loop, and the coolant inside is discharged under the pressure of the gas.

After draining the coolant of the liquid cooling pipeline 201, the multifunctional testing equipment 100 cleans the test object 200. The control component 102 adjusts the second liquid pipeline 20 to be in fluid communication with the liquid cooling pipeline 201. The cleaning liquid from the cleaning liquid storage device 400 flows into the liquid cooling pipeline 201 via the second liquid pipeline 20 to clean the liquid cooling pipeline 201. Technicians set the required cleaning duration and flow rate as needed.

After cleaning the liquid cooling pipeline 201, the multifunctional testing equipment 100 dries the test object 200. The control component 102 adjusts the gas pipeline 30 to be in fluid communication with the liquid cooling pipeline 201, and the external gas source delivers gas into the liquid cooling pipeline 201. The control component 102 activates the gas heating component 40, which heats the gas passing through the gas pipeline 30. The heated gas dries the liquid cooling pipeline 201. After drying is complete, the test object 200 is removed from the multifunctional testing equipment 100.

The terms used in the present application, such as “first” and “second”, do not intended to indicate any order, quantity, or importance of related components, but are only used for differentiation between the related components.

As used in the present application, the term “a” or “one” do not intended to limit the quantity of the related object, but to indicate the existence of at least one related object.

In the present application, the terms indicating direction or position, such as “top”, “bottom”, “side”, “longitudinal”, “transverse”, “middle”, “center, “outer”, “inner”, “horizontal”, “vertical”, “left”, “right”, “upper”, and “lower”, refers to a relative position rather than an absolute position.

The terms used in the present application, such as “substantially”, “whole”, “approximate”, and “similar”, are intended to indicate that the object has related characteristics but allow for certain deviations. The deviation may depend on a specific background. For example, the dimension of deviation may depend on a specific background, including but not limited to national standards for dimensional tolerances.

What is claimed is:

1. A multifunctional testing equipment, configured to detect a test object provided with a liquid cooling pipeline, the multifunctional testing equipment comprising:
a testing component, configured to be arranged inside the liquid cooling pipeline;
a gas pipeline, configured to be in fluid communication with the liquid cooling pipeline and an external gas source, thereby allowing gas to flow through the gas pipeline into the liquid cooling pipeline, wherein the testing component is configured to monitor a pressure change within the liquid cooling pipeline;
a first liquid pipeline, configured to be in fluid communication with the liquid cooling pipeline and a coolant storage device, thereby allowing coolant from the coolant storage device into the liquid cooling pipeline through the first liquid pipeline, wherein the testing component is further configured to monitor a flow rate of the coolant within the liquid cooling pipeline;
a second liquid pipeline, configured to be in fluid communication with the liquid cooling pipeline and a cleaning liquid storage device and guiding cleaning liquid from the cleaning liquid storage device to flow into the liquid cooling pipeline through the second liquid pipeline; and
a control component, configured to connect to the gas pipeline, the first liquid pipeline, and the second liquid pipeline and selectively control one of the gas pipeline, the first liquid pipeline, and the second liquid pipeline to establish fluid communication with the liquid cooling pipeline.

2. The multifunctional testing equipment to claim 1, further comprising a gas heating component, wherein the gas heating component is arranged on the gas pipeline and connected to the control component;
the gas heating component is configured to heat the gas flowing through the gas pipeline, thereby enabling the heated gas to dry the liquid cooling pipeline.

3. The multifunctional testing equipment to claim 2, further comprising a first humidity detection component and a second humidity detection component, wherein the first humidity detection component is configured to monitor a humidity value at an inlet of the liquid cooling pipeline, and the second humidity detection component is configured to monitor a humidity value at an outlet of the liquid cooling pipeline.

4. The multifunctional testing equipment to claim 1, wherein the first liquid pipeline comprises a first liquid inlet branch and a first liquid outlet branch;
the first liquid inlet branch is configured to be in fluid communication with an inlet of the liquid cooling pipeline and the coolant storage device, thereby allowing coolant from the coolant storage device into the liquid cooling pipeline;
the first liquid outlet branch is configured to be in fluid communication with an outlet of the liquid cooling pipeline and discharge coolant in the liquid cooling pipeline, thereby allowing the coolant in the liquid cooling pipe discharged along the first liquid outlet branch.

5. The multifunctional testing equipment to claim 4, wherein the control component is further configured to control to be in fluid communication with the first liquid outlet branch, the gas pipeline and the liquid cooling pipeline, thereby discharging the coolant in the liquid cooling pipeline through the first liquid outlet branch subjected to the gas flowing into the liquid cooling pipeline via the gas pipeline.

6. The multifunctional testing equipment to claim 4, wherein the first liquid pipeline further comprises a first liquid storage chamber;
the first liquid storage chamber is arranged on the first liquid inlet branch and is configured to accommodate the coolant to be injected into the liquid cooling pipeline through the first liquid inlet branch.

7. The multifunctional testing equipment to claim 6, further comprising a first liquid discharge pipeline;
the first liquid discharge pipeline is in fluid communication with the first liquid storage chamber and is configured to discharge the coolant from the first liquid storage chamber to an exterior of the multifunctional testing equipment.

8. The multifunctional testing equipment to claim 7, wherein the first liquid discharge pipeline is connected to the control component, and the control component is further configured to control the first liquid discharge pipeline to be in fluid communication with the first liquid storage chamber.

9. The multifunctional testing equipment to claim 4, wherein the first liquid pipeline further comprises a second liquid storage chamber;
the second liquid storage chamber is arranged on the first liquid outlet branch and is configured to accommodate the coolant discharged through the first liquid outlet branch.

10. The multifunctional testing equipment to claim 9, further comprising a second liquid discharge pipeline, wherein the second liquid discharge pipeline is configured to be in fluid communication with the second liquid storage chamber and is configured to discharge the coolant from the second liquid storage chamber to an exterior of the multifunctional testing equipment.

11. The multifunctional testing equipment to claim 10, wherein the second liquid discharge pipeline is connected to the control component, and the control component is further configured to control the second liquid discharge pipeline to be in fluid communication with the second liquid storage chamber.

12. The multifunctional testing equipment to claim 4, wherein the second liquid pipeline comprises a second liquid inlet branch and a second liquid outlet branch;
the second liquid inlet branch is configured to be in fluid communication with the inlet of the liquid cooling pipeline and the cleaning liquid storage device; and the second liquid outlet branch is configured to be in fluid communication with the outlet of the liquid cooling pipeline, when the second liquid outlet branch is in fluid communication with the outlet of the liquid cooling pipeline, the cleaning liquid in the cleaning liquid storage device flows into the liquid cooling pipeline through the second liquid inlet branch and is discharged through the second liquid outlet branch.

13. The multifunctional testing equipment to claim 12, wherein the control component is further configured to control to connect to the second liquid outlet branch, the gas pipeline and the liquid cooling pipeline, when the second liquid outlet branch, the gas pipeline and the liquid cooling pipeline are in fluid communication, the cleaning liquid in the liquid cooling pipeline is discharged through the second liquid outlet branch when gas flows into the liquid cooling pipeline via the gas pipeline.

14. The multifunctional testing equipment to claim 12, wherein a configuration of the first liquid inlet branch is same as a configuration of the second liquid inlet branch.

15. The multifunctional testing equipment to claim 12, wherein the second liquid pipeline further comprises a third liquid storage chamber;
the third liquid storage chamber is arranged on the second liquid outlet branch and is configured to accommodate the cleaning liquid discharged through the second liquid outlet branch.

16. The multifunctional testing equipment to claim 15, further comprising a third liquid discharge pipeline, wherein the third liquid discharge pipeline is configured to be in fluid communication with the third liquid storage chamber and is configured to discharge the cleaning liquid from the third liquid storage chamber to an exterior of the multifunctional testing equipment.

17. The multifunctional testing equipment to claim 16, wherein the third liquid discharge pipeline is further configured to be connected to the control component, and the control component is further configured to control the third liquid discharge pipeline to be in fluid communication with the third liquid storage chamber.

18. The multifunctional testing equipment to claim 1, wherein the gas pipeline comprises a first gas branch and a second gas branch; and the first gas branch and the second gas branch are configured to be connected to the control component;
the first gas branch is configured to be in fluid communication with to an external air compressor, the second gas branch is configured to be in fluid communication with a gas storage device, and the control component is further configured to control one of the first gas branch or the second gas branch to be in fluid communication with the liquid cooling pipeline.

19. The multifunctional testing equipment to claim 2, wherein the gas pipeline comprises a first gas branch and a second gas branch, the first gas branch and the second gas branch are configured to be connected to the control component, and the gas heating component is arranged on the first gas branch;
the first gas branch is configured to be in fluid communication with an external air compressor, the second gas branch is configured to be in fluid communication with a gas storage device, and the control component is further configured to control one of the first gas branch or the second gas branch to be in fluid communication with the liquid cooling pipeline.

20. A multifunctional testing equipment configured to detect a test object provided with a liquid cooling pipeline, the multifunctional testing equipment comprising:
a testing component, configured to be arranged inside the liquid cooling pipeline;
a gas pipeline, configured to be in fluid communication with the liquid cooling pipeline and an external gas source, thereby allowing gas to flow through the gas pipeline into the liquid cooling pipeline, wherein the testing component is configured to monitor a pressure change within the liquid cooling pipeline;
a first liquid pipeline, configured to be in fluid communication with the liquid cooling pipeline and a coolant storage device, thereby allowing coolant from the coolant storage device into the liquid cooling pipeline through the first liquid pipeline, wherein the testing component is further configured to monitor a flow rate of the coolant within the liquid cooling pipeline; and
a second liquid pipeline, configured to be in fluid communication with the liquid cooling pipeline and a cleaning liquid storage device, thereby allowing cleaning liquid from the cleaning liquid storage device to flow into the liquid cooling pipeline through the second liquid pipeline.
